(19) United States
(12) Patent Application Publication
(10) Pub. No.: US 2024/0193409 A1
(43) Pub. Date: Jun. 13, 2024

(54) TECHNIQUES FOR ACCELERATING MACHINE LEARNING MODELS

(71) Applicant: VIANAI SYSTEMS, INC., Palo Alto, CA (US)

(72) Inventors: Michael KEMELMAKHER, Hod Hasharon (IL); Gilad SABAN, Rehovot (IL); Naama KADOSH, Givatayim (IL); Tatiana OSOKIN, Herzliya (IL); Gil SHABAT, Hod Hasharon (IL)

(21) Appl. No.: 18/529,635

(22) Filed: Dec. 5, 2023

Related U.S. Application Data
(60) Provisional application No. 63/387,827, filed on Dec. 16, 2022.
(60) Provisional application No. 63/430,937, filed on Dec. 7, 2022.

(51) Int. Cl. G06N 3/0495; G06N 3/082

(52) U.S. Cl. CPC G06N 3/0495; G06N 3/082

(57) ABSTRACT

One embodiment of a method for accelerating a trained machine learning model includes parsing the trained machine learning model to identify one or more layers of the trained machine learning model and, for each layer included in the one or more layers, one or more corresponding compression techniques that can be applied to compress the layer, performing, based on a hardware device on which the trained machine learning model is intended to execute, one or more iterative operations to select, for each layer included in the one or more layers, a compression technique and values of one or more parameters associated with the compression technique, and compressing each layer included in the one or more layers using the compression technique that is selected for the layer and the values of the one or more parameters associated with the compression technique to generate a compressed trained machine learning model.

### CROSS-REFERENCE TO RELATED APPLICATIONS

This application claims priority benefit of the United States Provisional Patent Application titled, “DEEP NEURAL NETWORKS ACCELERATION FRAMEWORK,” filed on Dec. 7, 2022, and having Ser. No. 63/430,937 and the United States Provisional Patent Application titled, “DEEP NEURAL NETWORKS ACCELERATION FRAMEWORK,” filed on Dec. 16, 2022, and having Ser. No. 63/387,827. The subject matter of these related applications is hereby incorporated herein by reference.

### BACKGROUND

### Field of the Various Embodiments

The contemplated embodiments relate generally to computer science and machine learning and, more specifically, to techniques for accelerating machine learning models.

### Description of the Related Art

Machine learning can be used to discover trends, patterns, relationships, and/or other attributes related to large sets of complex, interconnected, and/or multidimensional data. To glean insights from large data sets, regression models, artificial neural networks, support vector machines, decision trees, naïve Bayes classifiers, and/or other types of machine learning models can be trained using input-output pairs in the data. In turn, the discovered information can be used to guide decisions and/or perform actions related to the data.

Within machine learning, neural networks can be trained to perform a wide range of tasks with a high degree of accuracy. Neural networks are therefore becoming widely adopted in the field of artificial intelligence. Neural networks can have a diverse range of network architectures. In more complex scenarios, the network architecture for a neural network can include many different types of layers with an intricate topology of connections among the different layers. For example, some neural networks can have ten or more layers, where each layer can include hundreds or thousands of neurons and can be coupled to one or more other layers via hundreds or thousands of individual connections. Such complex neural networks are sometimes referred to as “deep neural networks” (DNNs).

Inferencing is the process of executing a trained machine learning model to make predictions on new data. Executing machine learning models, such as DNNs, is oftentimes very computationally expensive and can consume a significant amount of power. In addition, some machine learning models, such as DNNs, can be relatively large in size. Computing devices that have limited processing capability, memory, storage, and/or available power can have difficulty executing, or be entirely unable to execute, machine learning models such as DNNs. For example, the computing devices in autonomous vehicles have, as a general matter, less processing capability and storage than the cloud computing systems used to train some DNNs. As a result, the computing devices in autonomous vehicles may be unable to store and/or effectively execute such DNNs that are trained using cloud computing systems. As another example, when DNNs that consume a significant amount of power are executed on computing devices that run on battery power, the battery power can be quickly depleted.

One conventional approach for accelerating trained machine learning models is to reduce the precision of numerical parameter values used in those machine learning models. As used herein, accelerating a trained machine learning model refers to reducing the computational requirements for executing the trained machine learning model, which can be associated with a reduction in size and/or power consumption of the trained machine learning model. A trained machine learning model that includes higher precision parameter values can require more space to store and more computations to execute relative to a trained machine learning model that includes lower precision parameter values. Reducing the precision of parameter values in the trained machine learning model can, therefore, reduce the computational and storage requirements of the trained machine learning model. One drawback of reducing the precision of parameter values in a trained machine learning model, however, is the resulting machine learning model can produce less accurate output.

Another conventional approach for accelerating trained machine learning models is hardware acceleration. Hardware acceleration involves executing trained machine learning models on specialized hardware, such as graphics processing units (GPUs) or tensor processing units (TPUs). One drawback of this type of hardware acceleration is the trained machine learning models are limited to execute on the specialized hardware. Accordingly, trained machine learning models that require hardware acceleration oftentimes cannot be executed across computing devices with different types of hardware.

As the forgoing illustrates, what is needed in the art are more effective techniques for accelerating trained machine learning models.

### SUMMARY

One embodiment of the present disclosure sets forth a computer-implemented method for accelerating a trained machine learning model. The method includes parsing the trained machine learning model to identify one or more layers of the trained machine learning model and, for each layer included in the one or more layers, one or more corresponding compression techniques that can be applied to compress the layer. The method further includes performing, based on a hardware device on which the trained machine learning model is intended to execute, one or more iterative operations to select, for each layer included in the one or more layers, a compression technique included in the one or more corresponding compression techniques and values of one or more parameters associated with the compression technique. In addition, the method includes compressing each layer included in the one or more layers using the compression technique that is selected for the layer and the values of the one or more parameters associated with the compression technique to generate a compressed trained machine learning model.

Other embodiments of the present disclosure include, without limitation, one or more computer-readable media including instructions for performing one or more aspects of the disclosed techniques as well as one or more computing systems for performing one or more aspects of the disclosed techniques.

One technical advantage of the disclosed techniques relative to the prior art is the disclosed techniques reduce the computational complexity and/or size of a trained machine learning model, such as a DNN, while preserving the accuracy of the trained machine learning model to some degree. When the computational complexity of a trained machine learning model is reduced, the trained machine learning model can execute faster, with lower latency and higher throughput, and/or with decreased power consumption. When the size of a trained machine learning model is reduced, the trained machine learning model can have a smaller memory footprint and require less storage space to store. Reducing the computational complexity and/or size of a trained machine learning model can permit the trained machine learning model to be executed on some computing devices that have limited processing capability, memory, storage, and/or available power. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments;

FIG. 2 is a more detailed illustration of the machine learning model acceleration application of FIG. 1, according to various embodiments;

FIG. 3 is a more detailed illustration of the acceleration engine of FIG. 2, according to various embodiments;

FIG. 4 is a flow diagram of method steps for accelerating a trained machine learning model, according to various embodiments; and

FIG. 5 is a flow diagram of method steps for performing optimization to compress a trained machine learning model, according to various embodiments.

### DETAILED DESCRIPTION

In the following description, numerous specific details are set forth to provide a more thorough understanding of the various embodiments. However, it will be apparent to one skilled in the art that the inventive concepts can be practiced without one or more of these specific details.

### System Overview

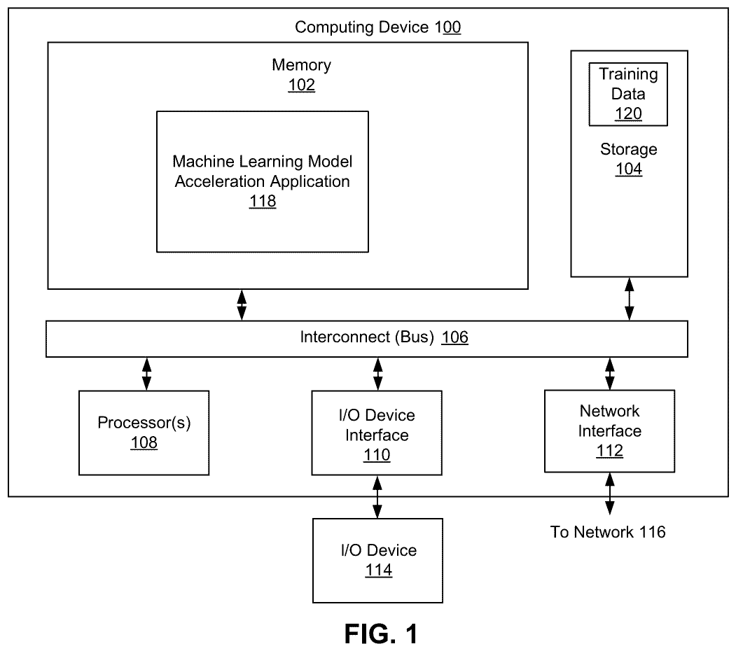

FIG. 1 illustrates a computing device 100 configured to implement one or more aspects of the present disclosure. As shown, computing device 100 includes, without limitation, a memory 102, a storage 104, an interconnect (bus) 106, one or more processor(s) 108, an input/output (I/O) device interface 110 coupled to one or more input/output (I/O) devices 114, and a network interface 112 coupled with network 116.

In some embodiments, computing device 100 can be a desktop computer, a laptop computer, a smart phone, a personal digital assistant (PDA), tablet computer, a remote server, or any other type of computing device configured to receive input, process data, and optionally display images, and is suitable for practicing one or more embodiments. Computing device 100 described herein is illustrative and any other technically feasible configurations fall within the scope of the present disclosure.

In some embodiments, processor(s) 108 can include any suitable implemented as a central processing unit (CPU), a graphics processing unit (GPU), an application-specific integrated circuit (ASIC), a field programmable gate array (FPGA), an artificial intelligence (AI) accelerator, a multi-core processor, any other type of processor, or a combination of two or more processors of a same or different types. For example, processor(s) 108 could include a CPU and a GPU configured to operate in conjunction with each other. In general, processor(s) 108 can be any technically feasible hardware unit capable of processing data and/or executing software applications. Further, in the context of this disclosure, the computing elements shown in computing device 100 can correspond to a physical computing system (e.g., a system in a data center) or can be a virtual computing instance executing within a computing cloud.

I/O device interface 110 enables communication of I/O devices 114 with processor(s) 108. I/O device interface 110 generally includes the logic for interpreting addresses corresponding to I/O devices 114 that are generated by processor(s) 108. I/O device interface 110 can also be configured to implement handshaking between processor(s) 108 and I/O devices 114, and/or generate interrupts associated with I/O devices 114. I/O device interface 110 can be implemented as any technically feasible CPU, ASIC, FPGA, and/or any other type of processing unit or device.

In some embodiments, I/O devices 114 include devices capable of providing input, such as a keyboard, a mouse, a touch-sensitive screen, and so forth, as well as devices capable of providing output, such as a display device. Additionally, I/O devices 114 can include devices capable of both receiving input and providing output, such as a touchscreen, a universal serial bus (USB) port, and so forth. I/O devices 114 can be configured to receive various types of input from an end-user (e.g., a designer) of computing device 100, and to also provide various types of output to the end-user of computing device 100, such as displayed digital images or digital videos or text. In some embodiments, one or more of I/O devices 114 are configured to couple computing device 100 to a network interface 112.

In some embodiments, network 116 can be any technically feasible type of communications network that allows data to be exchanged between computing device 100 and external entities or devices, such as a web server or another networked computing device. For example, network 116 could be a wide area network (WAN), a local area network (LAN), a wireless (WiFi) network, and/or the Internet, among others. Processor(s) 108, I/O device interface 110, and network interface 112 are configured to read data from and write data to memory 102. Network 116 can connect multiple instances of computing device 100 (e.g., within a data center, cluster, cloud computing environment, etc.) to allow applications to operate in a parallel, distributed, and/or scalable fashion.

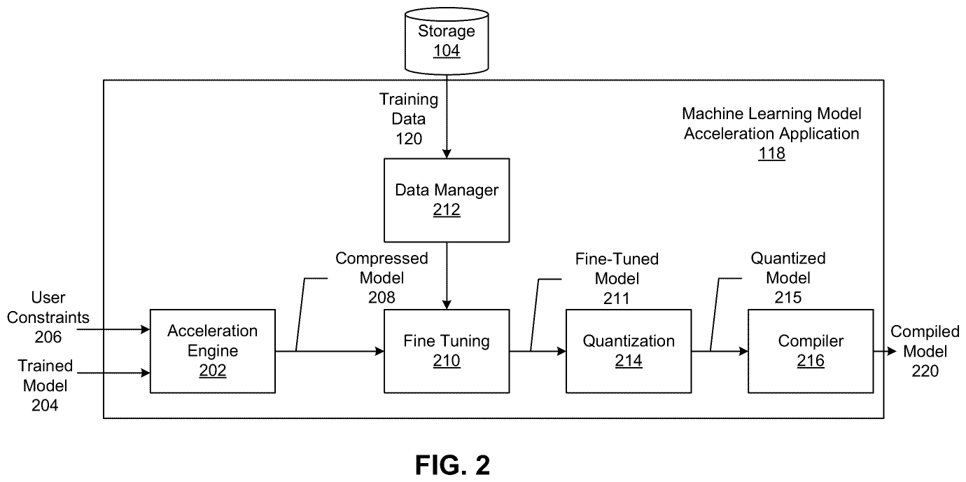

In some embodiments, memory 102 can be a random-access memory (wRAM) module, a flash memory unit, or any other type of memory unit or combination thereof. Processor(s) 108, I/O device interface 110, and network interface 112 are configured to read data from and write data to memory 102. Memory 102 can store various software programs that can be executed by processor(s) 108 and application data associated with the software programs. Illustratively, memory 102 stores a machine learning model acceleration application 118 (also referred to herein as “acceleration application 118). In some embodiments, acceleration application 118 is configured to reduce the computational complexity and/or size of trained machine learning models so that the trained machine learning models can be, e.g., deployed on resource-constrained computing devices, as discussed in greater detail below in conjunction with FIGS. 2-5.

Storage 104 can be a non-volatile storage for applications and data, and can be fixed or removable disk drives, flash memory devices, and CD-ROM, DVD-ROM, Blu-Ray, HD-DVD, or other magnetic, optical, or solid state storage devices. Illustratively, storage 104 stores training data 120, which can include one or more data sets for training, validation, and/or testing machine learning models. Training data 120 and/or acceleration application 118 can be stored in storage 104 and loaded into memory 102 for execution by processor(s) 108.

It will be appreciated that the computing device 100 shown herein is illustrative and that variations and modifications are possible. The connection topology, including the number and arrangement of interconnects, the number of processors 108, etc., may be modified as desired. For example, in some embodiments, memory 102 could be connected to processors 108 directly rather than through interconnect 106, and other devices would communicate with system memory 102 via interconnect 106 and processors 108. In other embodiments, a parallel processing subsystem may be connected to I/O device interface 110 or directly to processors 108. In still other embodiments, I/O device interface 110 and interconnect 106 may be integrated into a single chip instead of existing as one or more discrete devices. In addition, in certain embodiments, one or more components shown in FIG. 1 may not be present.

### Accelerating Machine Learning Models

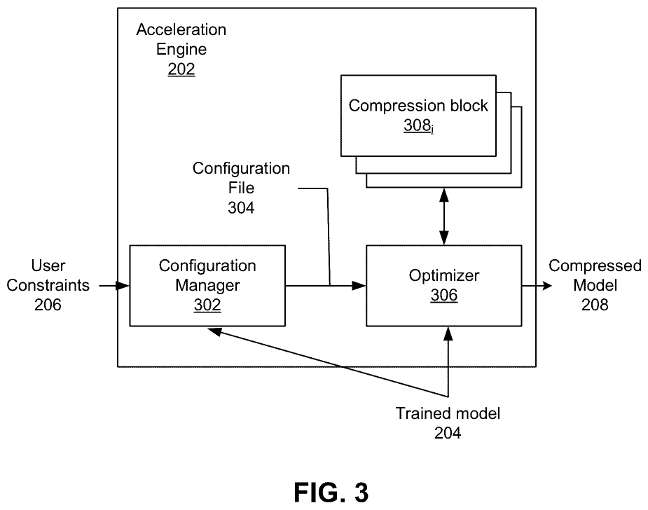

FIG. 2 is a more detailed illustration of the machine learning model acceleration application 118 of FIG. 1, according to various embodiments. As shown, acceleration application 118 includes an acceleration engine 202, a fine tuning module 210, a data manager 212, a quantization module 214, and a compiler module 216. In operation, acceleration engine 202 receives a trained machine learning model 204 (also referred to herein as “trained model 204”) and user constraints 206 as input, and acceleration engine 202 generates a compressed model 208 that is faster, requires less computations, and/or has a smaller memory footprint than trained model 204. In some embodiments, acceleration engine 202 parses the input machine learning model 204 to identify components thereof, such as the layers of a neural network, as well as optimization blocks that can used to replace the identified components. In such cases, acceleration engine 202 also performs an iterative optimization procedure to determine, for the identified components, particular optimization blocks and associated parameter values that can be used to generate a compressed version of trained model 204 that maximizes (or minimizes) an objective function, such as an objective function based on execution speed and/or accuracy, while satisfying user constraints 206. In addition, acceleration engine 202 performs the optimization techniques associated with the particular optimization blocks to generate compressed model 208. The components of acceleration engine 202 are discussed in greater detail below in conjunction with FIG. 3.

In some cases, compressed model 208 that is generated by acceleration engine 202 can have less accuracy than the original trained model 204. In order to remedy any decrease in accuracy, fine tuning module 210 performs re-training of compressed model 208 to generate fine-tuned model 211. Illustratively, fine tuning module 210 re-trains compressed model 208 using training data 120 or a subset of training data 120 that is stored in storage 104 and imported by data manager 212. In some embodiments, the fine tuning can improve the performance of compressed model 208 on a target task, and training data 120 can include a data set that is specific to the target task and smaller than a dataset that was previously used to train trained model 204. Any technically feasible fine tuning can be performed in some embodiments. For example, in some embodiments, fine tuning module 210 freezes one or more layers of compressed model 208 and re-trains the other layers of compressed model 208. Freezing means that weights of the frozen layers are not updated during fine-tuning, preserving the knowledge gained during previous training of trained model 204. As another example, in some embodiments, fine tuning module 210 can adjust the weights, biases, and/or other parameters of compressed model 208 to enhance the performance of compressed model 208. Although fine tuning module 210 is shown as following acceleration engine 202 for illustrative purposes, in some embodiments, the iterative optimization performed by acceleration engine 202 can include fine tuning of the compressed models that are generated during different iterations of the optimization.

Data manager 212 defines and manages the interfaces between training data 120 and acceleration application 118. In some embodiments, data manager 212 communicates with storage 104 to efficiently load, manage, validate, and/or test data sets, such as training data 120, during model training and/or fine tuning.

Quantization module 214 performs one or more quantization techniques on fine-tuned model 211 that reduce the precision or bit-width of numerical representations used by fine-tuned model 211, such as numeral representations that are used to store model parameters and activations of a neural network. In some embodiments, the parameters and activations can be represented as high-precision (e.g., 32-bit or 64-bit) floating-point numbers. In such cases, quantization module 214 receives fine-tuned model 211 from fine tuning module 210, replaces the high-precision numbers with lower-precision alternatives, and saves the resulting model as quantized model 215. In some embodiments, the AdaRound technique can be performed in order to reduce quantization noise.

Compiler module 216 translates high-level source code in a programming language into machine code or an intermediate code that can be executed by a computer. Illustratively, compiler module 216 receives quantized model 215 from quantization module 214 and generates compiled model 220 by translating source code associated with quantized model 215 into machine code or intermediate code that can be executed on a target hardware platform. Compiler module 216 can perform any technically feasible compilation of quantized model 215 in some embodiments. For example, compiler module 216 could use TVM/ONNX providers to compile quantized model 215. Subsequent to compilation, compiled model 220 can be deployed to execute on any suitable computing device for which compiled model 220 was compressed, quantized, and compiled, as described above.

In some embodiments, acceleration application 118 can also fuse one or more components of quantized model 215 prior to compiling quantized model 115. For example, if quantized model 215 is a neural network that includes a sequence of repeating layers, acceleration application 118 could fuse the repeating layers into one operation. More generally, operator fusion can be performed to combine multiple operators of a machine learning model into a single kernel without saving the intermediate results in memory. Doing so can significantly reduce the execution time of a quantized model, particularly in GPUs and specialized accelerators.

FIG. 3 is a more detailed illustration of acceleration engine 202 of FIG. 2, according to various embodiments. As shown, acceleration engine 202 includes a configuration manager 302, an optimizer module 306 (also referred to herein as “optimizer 306”), and compression blocks 308i (referred to herein collectively as “compression blocks 308” and individually as a “compression block 308”). Configuration manager 302 takes as inputs user constraints 206 and trained model 204, which as described can be a neural network (e.g., a deep neural network) that includes a number of layers. Given such inputs, configuration manager 302 creates a configuration file 304 that indicates to optimizer 306 which compression blocks 308 can be used to replace different components (e.g., network layers or blocks) of trained model 204 in order to generate compressed model 208. In some embodiments, configuration manager 302 can import the structure of trained model 204 by recursively scanning a computational graph associated with trained model 204 to identify model components, such as neural network layers, that can be accelerated or compressed. In some embodiments, configuration manager 302 also determines a quantization level for compressing the identified model components and/or other parameters.

For example, in some embodiments, configuration manager 302 can identify components of trained model 204 as described above, calculate a theoretical number of computations required by each component and a theoretical memory footprint of trained model 204, execute trained model 204 on target hardware to determine the actual complexity of trained model 204 and components thereof as well as the actual memory footprint of trained model 204, identify differences between the theoretical and actual number of computations and memory footprint, and generate configuration file 304 to account for such information. In such cases, configuration manager 302 can further identify compression blocks that can be used to replace each component of trained model 204 based on, e.g., predefined relationships between those compression blocks and certain types of model components that the compression blocks can be used to replace, the target hardware (which may operate better when certain types of compression are performed on the model components), etc. In addition, configuration manager 302 can also determine an amount by which each component of trained model 204 can be compressed based on, e.g., redundant information in the component. For example, in order to indicate that the convolution block of a trained neural network can be replaced by a Tensor decomposition of the convolution block that compresses the convolution block by a factor of 4, configuration manager 302 can generate configuration file 304 to specify the Tensor decomposition technique in a “name” field and the compression factor 0.25 in an arguments “args” field.

In some other embodiments, configuration manager 302 can also permit a user to modify configuration file 304 via, e.g., a user interface (UI). In addition, in some embodiments, the configuration manager 302 can gather all the information needed to load a dataset, modify trained model 204, and manage training and/or retraining of trained model 204.

Optimizer 306 is configured to perform an iterative optimization technique to optimize (1) the types of compression blocks that are used to replace one or more components of trained model 204 that are specified in configuration file 304, and (2) parameters associated with the compression blocks. In some embodiments, the iterative optimization seeks to maximize (or alternatively, minimize) an objective function, such as execution speed, model size, latency or throughput versus time, number of operations, etc., and/or a combination thereof. For example, in some embodiments, the iterative optimization can be used to optimize trained model 204 while accounting for the tradeoff between speed and accuracy of the optimized model. In such cases, the accuracy can be computed according to an accuracy function that acceleration application 118 takes as input. In some embodiments, the iterative optimization can be subject to a user-specified constraint 206, such as a minimum acceptable accuracy of the compressed model, a maximum execution time, a constraint that certain layers of trained model 204 are fixed during optimization, etc. In some embodiments, multiple components, such as a subset of the layers of a neural network, can be compressed at the same time during the iterative optimization. In some embodiments, optimizer 306 can present to a user different optimization options and permit the user to select one of those options via, e.g., a UI.

In some embodiments, optimizer 306 performs optimization in two ways. First, optimizer 306 can modify the architecture of trained model 204 by using compression blocks 308 to replace components within trained model 204. An example of a compression block 308 is a decomposition block that replaces a single tensor representing a layer within a neural network with several tensors that the single tensor decomposes into. Second, optimizer 306 can optimize parameters, and in particular hyperparameters, associated with compression blocks 308. Returning to the example of decomposing a tensor representing a neural network layer into several matrices, optimizer 306 could optimize hyperparameters such as the sizes of the several matrices in order to maximize an execution speed or other objective function, while taking into account the target hardware on which the compressed model will execute. In some embodiments, the optimizer 306 can iterate between choosing different compression blocks 308 that are used to replace components (e.g., a subset of layers) of a machine learning model and optimizing parameters associated with the chosen compression blocks 308. In such cases, the optimizer 306 can compute the objective function (e.g., a function of execution speed and accuracy) after each iteration of the optimization and attempt to increase (or alternatively, reduce) the computed objective function over time. For example, in some embodiments, optimizer 306 can perform a reinforcement learning technique to increase the computed objective function over time. In some embodiments, the iterative optimization terminates when a predefined criterion or criteria for optimization is met. For example, when the objective function is based on execution speed, the iterative optimization could terminate when the execution speed of a model being optimized does not improve over a number (e.g., 10) of iterations. As another example, the termination condition could be achieving a given level of compression while maintaining a desired model accuracy. In some embodiments, the iterative optimization performed by optimizer 306 can also include fine tuning of the compressed models that are generated during different iterations of the optimization.

Compression blocks 308 provide faster alternatives to components of machine learning models that can be used to replace those components. The specific compression blocks 308 and associated parameters that are used to replace particular components of a machine learning model can be chosen by optimizer 306 via the iterative optimization technique, described above, according to a specific scenario such as the desired accuracy or model size, target hardware, user-specified optimization constraints, dataset, etc., which can be accounted for using, e.g., the objective function that is maximized (or minimized) during optimization.

In some embodiments, one or more of compression blocks 308 can use a Canonical Polyadic (CP) tensor decomposition technique in which an input convolution Cᵢₙ is replaced by three convolutional layers with shapes (Cᵢₙ×R1×1), (R×R×D×D), and (R×Cₒᵤₜ×1×1) respectively. In such a structure, all spatial convolutions are performed by the central D×D group convolution with R channels. 1×1 convolutions allow the transfer of input data to a more compact channel space (with R channels) and then returns data to the initial channel space. The number of parameters for a CP model of rank-R is R(2D+S+T) or R(D2+S+T) considering kernels as order-4 tensors or reshaped into order-3 versions, respectively. In some embodiments, the rank of a tensor can be estimated using, e.g., the variational Bayesian matrix factorization (VBMF) technique. The compression blocks 308 that employ CP tensor decomposition can achieve a relatively high compression ratio since the decomposition rank is not very large.

In some embodiments, one or more of compression blocks 308 can use a Tucker tensor decomposition (TKD) technique in which an input convolution is replaced by three convolutional layers with shapes (Cᵢₙ×R1×1×1), Regular Conv2D (R1×R2×D×D) and (R2×Cₒᵤₜ×1×1), respectively. The TKD technique provides a relatively flexible interaction between the factor matrices through a core tensor, which is often dense in practice. The TKD technique can provide less acceleration and compression relative to the CP, but the TKD technique can be easier to tune.

In some embodiments, one or more of compression blocks 308 can use a pruning technique or a mix of more than one pruning technique. As used herein, pruning refers to removing weights, filters, neurons, and/or other structures from a neural network. In some embodiments, compression blocks 308 can include weight (unstructured) and channel (structured) pruning blocks. In unstructured pruning, specific weights in filters of a neural network are zeroed. In structured pruning, entire filters are removed from a neural network. In some embodiments, compression blocks 308 can include local and global pruning blocks. Local pruning removes a fixed percentage of weights from each layer of a neural network. Global pruning pools all parameters together across layers of a neural network and selects a global fraction of the pooled parameters to prune. In some embodiments, one or more of compression blocks 308 pool together only parameters belonging to layers of the same kind to avoid mixing different types of network layers, such as convolutional layers and fully-connected layers. In some other embodiments, one or more of compression blocks 308 use L1, L2, and/or random pruning. L1 prunes filters with the smallest sum of the absolute weights of a filter. L2 prunes filters by minimizing the largest singular value of a filter. Random pruning prunes filters randomly. In some embodiments, one or more of compression blocks 308 use filter pruning via geometric median (FPGM) pruning. In FPGM pruning, for each layer of a neural network, filters that are closest to other filters by Euclidean distance are pruned.

In some embodiments, one or more of compression blocks 308 use an Energy Threshold (QR) technique that decomposes a filter F of size (Cᵢₙ×Cₒᵤₜ×1×1) with pivoted QR:

FP=QR. (1)

In equation (1), P represents the channels ordered, from the most important to the least important according to how well the channel's combination can reconstruct the original filter. The number of pruned channels depends on the energy percentage that should be eliminated. Channel energy can defined as:

Eₖ=Σₜ₌₁^{k}Σⱼ₌₁ⁱR_{j,i}² for k=1 . . . Cₒᵤₜ,RϵR^{C}^{ᵢₙ}^{×C}^{ₒᵤₜ}(2)

In some embodiments, one or more of compression blocks 308 use a Nystromformer to approximate the softmax component of the attention block of one or more transformers in a neural network.

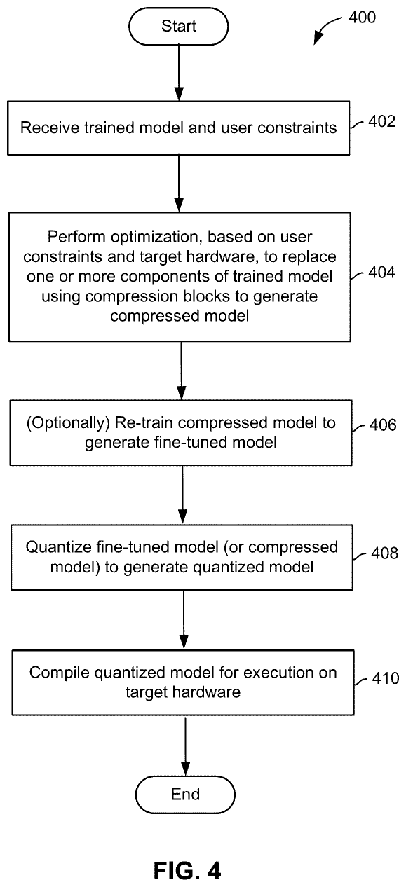

FIG. 4 is a flow diagram of method steps for accelerating a trained machine learning model, according to various embodiments. Although the method steps are described in conjunction with FIG. 1-3, persons skilled in the art will understand that any system configured to perform the method steps, in any order, falls within the scope of the present disclosure.

As shown, a method 400 begins at step 402, where acceleration engine 202 receives trained model 204 and user constraints 206.

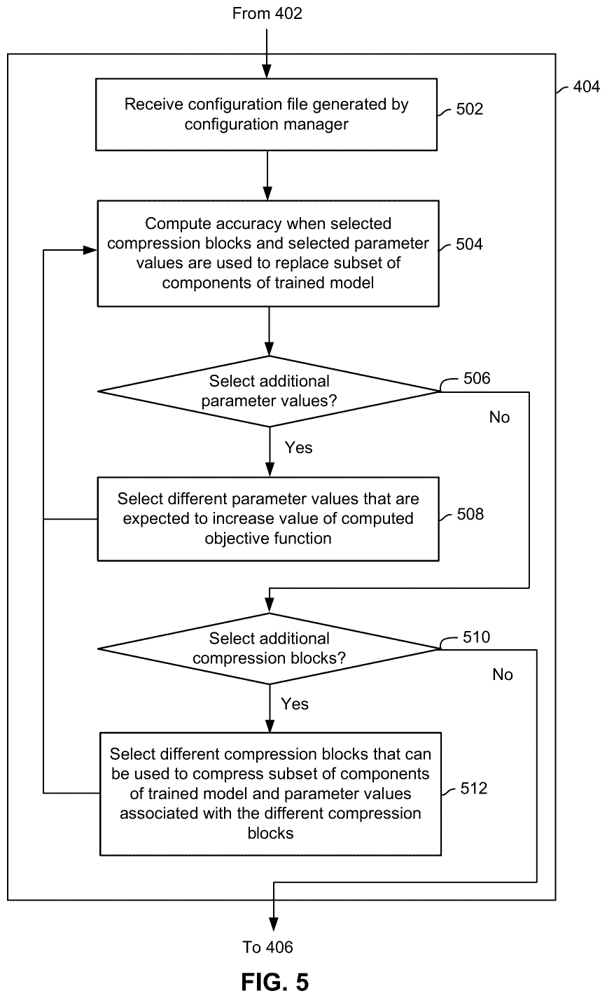

At step 404, acceleration engine 404 performs optimization, based on the user constraints 206 and target hardware on which an accelerated model is intended to execute, to replace one or more components of trained model 204 using compression blocks 308 to generate compressed model 208. The optimization at step 404 is discussed in greater detail below in conjunction with FIG. 5.

At step 406, fine tuning module 210 optionally re-trains compressed model 208. For example, if the user constraints 206 include a desired level of accuracy that compressed model 208 is unable to achieve, then fine tuning module 210 can re-train compressed model 208 to improve the accuracy to the desired level. In some embodiments, training data or a subset of training data used to re-train compressed model 208 can be loaded from storage 104 and processed by data manager 212.

At step 408, quantization module 214 quantizes fine-tuned model 211 (or compressed model 208 if compressed model 208 is not re-trained) to generate quantized model 215. As described, quantization can reduce the number of computations and allow a compressed model to execute even faster with a smaller memory footprint.

At step 410, compiler module 216 compiles quantized model 215 into compiled model 220 for execution on a target hardware platform. Examples of target hardware platforms include mobile devices, wearable devices, internet of things (IOT) devices, personal computers, etc.

FIG. 5 is a flow diagram of method steps for performing optimization to compress a trained machine learning model, according to various embodiments. Although the method steps are described in conjunction with FIG. 1-3, persons skilled in the art will understand that any system configured to perform the method steps, in any order, falls within the scope of the present disclosure.

The method 500 begins at step 502, where optimizer 306 receives configuration file 304 generated by configuration manager 302. As described, configuration manager 302 processes user constraints 204 and parses trained model 204 to generate configuration file 304, which can include components (e.g., network layers) of trained model 204, compression blocks that are relevant to the components and target hardware, and/or an amount by which to compress the components.

At step 504, optimizer 306 computes an accuracy when selected compression blocks and selected parameter values are used to replace a subset of components of trained model 204. As described above in conjunction with FIG. 3, in some embodiments, compression blocks that can be used to replace components of trained model 204 are indicated by configuration 304, and each compression block can have associated parameters, such as hyperparameters of one or more compressed components that are generated via the compression block, that can be modified. In addition, in some embodiments, the accuracy can be computed at step 504 according to a function that acceleration application 118 receives as input. In some embodiments, optimizer 306 can also perform fine tuning of trained model 204 after replacing the subset of components of trained model 204 with the selected compression blocks and the selected parameter values, and the fine tuning attempts to ensure a desired level of accuracy of the resulting model.

At step 506, optimizer 306 determines whether to select additional parameter values. For example, optimizer 306 could stop selecting parameter values when the execution speed of the model being optimized does not improve over a number (e.g., 10) of iterations.

If optimizer 306 determines to select additional parameter values at step 506, then method 500 continues to step 508, where optimizer 306 selects different parameter values that are expected to increase (or decrease) the value of a computed objective function, such as execution speed. In some embodiments, optimizer 306 can select additional parameter values by performing reinforcement learning. In reinforcement learning, optimizer 306 learns to make decisions through trial and error, during which optimizer 306 receives feedback in the form of rewards and/or penalties based on decisions by optimizer 306, enabling optimizer 306 to learn optimal solutions over time. Method 500 then returns to step 504, where optimizer 306 again computes an accuracy when the selected compression blocks and the selected parameter values are used to replace the subset of components of trained model 204.

On the other hand, if optimizer 306 determines to stop selecting parameter values at step 506, then at step 510, optimizer 306 determines whether to select additional compression blocks. In some embodiments, any technically feasible terminating condition can be used. For example, in some embodiments, the terminating condition can be achieving a given level of compression while maintaining a desired model accuracy. As another example, in some embodiments, the terminating condition can be that execution speed of the model being optimized does not improve over a number of iterations. As a further example, in some embodiments, the terminating condition can be that a desired level of model accuracy is not preserved even after fine tuning. As yet another example, in some embodiments, the terminating condition can be the computational cost of selected compression blocks exceeding the computational cost of the previous best selected compression blocks. In some embodiments, method 500 can continue indefinitely, so long as the model accuracy can be preserved (including via fine tuning) and the computational cost of compression makes sense given the achieved acceleration factor.

If optimizer 306 determines to select additional compression blocks at step 510, then method 500 continues to step 512, where optimizer selects different compression blocks that can be used to compress the subset of components of trained model 204 and parameter values associated with the different compression blocks. The different compression blocks can be selected in any technically feasible manner in some embodiments. In some embodiments, optimizer 306 can select compression blocks based on model profiling on the actual target hardware. In model profiling, optimizer 306 prioritizes compression blocks based on the time of execution of the specific block or memory consumption of the specific block on the target hardware. Although step 512 is described with respect to selecting different compression blocks for simplicity, in some embodiments, one or more of the selected compression blocks can be the same as previously selected compression blocks.

Method 500 then returns to step 504, where optimizer 306 again computes an accuracy when the selected compression blocks and the selected parameter values are used to replace the subset of components of trained model 204.

On the other hand, if optimizer 306 determines to stop selecting additional compression blocks at step 510, then method 500 ends. In sum, techniques are disclosed for accelerating trained machine learning models. In some embodiments, an acceleration application receives as input a trained machine learning model, a training and validation data set, a target hardware platform, and one or more user-specified constraints. Given such inputs, the acceleration application performs an iterative optimization technique to generate a compressed machine learning model by optimizing (1) an architecture of the trained model in which one or more components of the trained model are replaced by one or more compressed components generated using one or more compression blocks, and (2) parameters associated the one or more compression blocks. The optimization can be subject to the user-specified constraints. Further, the optimization process can utilize a configuration file that is created by parsing the trained machine learning model to determine components thereof, compression blocks that are applicable to the components given the target hardware platform, and amounts to which the components can be compressed. If the compressed machine learning model does not meet a desired level of accuracy, then the compressed machine learning model is re-trained using the training and validation data set. Subsequent to the compression and (optional) re-training, the acceleration application further improves the model performance by performing a quantization technique that is selected based on the target hardware platform. The quantization reduces the precision of numerical values used in the compressed (and optionally re-trained) model. Thereafter, the acceleration application compiles the quantized model for execution on the hardware platform.

One technical advantage of the disclosed techniques relative to the prior art is the disclosed techniques reduce the computational complexity and/or size of a trained machine learning model, such as a DNN, while preserving the accuracy of the trained machine learning model to some degree. When the computational complexity of a trained machine learning model is reduced, the trained machine learning model can execute faster, with lower latency and higher throughput, and/or with decreased power consumption. When the size of a trained machine learning model is reduced, the trained machine learning model can have a smaller memory footprint and require less storage space to store. Reducing the computational complexity and/or size of a trained machine learning model can permit the trained machine learning model to be executed on some computing devices that have limited processing capability, memory, storage, and/or available power. These technical advantages provide one or more technological improvements over prior art approaches.

1. In some embodiments, a computer-implemented method for accelerating a trained machine learning model comprises parsing the trained machine learning model to identify one or more layers of the trained machine learning model and, for each layer included in the one or more layers, one or more corresponding compression techniques that can be applied to compress the layer, performing, based on a hardware device on which the trained machine learning model is intended to execute, one or more iterative operations to select, for each layer included in the one or more layers, a compression technique included in the one or more corresponding compression techniques and values of one or more parameters associated with the compression technique, and compressing each layer included in the one or more layers using the compression technique that is selected for the layer and the values of the one or more parameters associated with the compression technique to generate a compressed trained machine learning model.

2. The computer-implemented method of clause 1, further comprising performing one or more quantization operations on the compressed trained machine learning model to generate a quantized trained machine learning model.

3. The computer-implemented method of clauses 1 or 2, wherein the one or more iterative operations comprise one or more reinforcement learning operations.

4. The computer-implemented method of any of clauses 1-3, where the compression technique included in the one or more corresponding compression techniques comprises at least one of a pruning technique, a decomposition technique, or an approximation technique.

5. The computer-implemented method of any of clauses 1-4, wherein the one or more iterative operations are further based on at least one of a predefined accuracy constraint or a predefined execution speed constraint.

6. The computer-implemented method of any of clauses 1-5, further comprising, in response to determining that the compressed trained machine learning model does not satisfy a predefined accuracy constraint, performing one or more operations to re-train the compressed trained machine learning model.

7. The computer-implemented method of any of clauses 1-6, further comprising performing one or more operations to fuse at least two layers included in the one or more layers to generate a fused layer.

8. The computer-implemented method of any of clauses 1-7, further comprising updating, based on user input, the one or more corresponding compression techniques for at least one layer included in the one or more layers.

9. The computer-implemented method of any of clauses 1-8, further comprising performing one or more operations to convert the compressed trained machine learning model to a binary format that is executable via the hardware device.

10. The computer-implemented method of any of clauses 1-9, wherein the trained machine learning model comprises a trained artificial neural network.

11. In some embodiments, one or more non-transitory computer readable media include instructions that, when executed by one or more processors, cause the one or more processors to perform the steps of parsing a trained machine learning model to identify one or more layers of the trained machine learning model and, for each layer included in the one or more layers, one or more corresponding compression techniques that can be applied to compress the layer, performing, based on a hardware device on which the trained machine learning model is intended to execute, one or more iterative operations to select, for each layer included in the one or more layers, a compression technique included in the one or more corresponding compression techniques and values of one or more parameters associated with the compression technique, and compressing each layer included in the one or more layers using the compression technique that is selected for the layer and the values of the one or more parameters associated with the compression technique to generate a compressed trained machine learning model.

12. The one or more non-transitory computer readable media of clause 11, wherein the instructions, when executed by the one or more processors, further cause the one or more processors to perform the step of performing one or more quantization operations on the compressed trained machine learning model to generate a quantized trained machine learning model.

13. The one or more non-transitory computer readable media of clauses 11 or 12, wherein the one or more iterative operations are further based on at least one of a predefined accuracy constraint or a predefined execution speed constraint.

14. The one or more non-transitory computer readable media of any of clauses 11-13, where the compression technique included in the one or more corresponding compression techniques comprises at least one of a pruning technique, a decomposition technique, or an approximation technique.

15. The one or more non-transitory computer readable media of any of clauses 11-14, where the compression technique included in the one or more corresponding compression techniques comprises at least one of a global pruning technique, a local pruning technique, a filter pruning via geometric median (FPGM) technique, a structured pruning technique, an unstructured pruning technique, an Energy Threshold (QR) technique, a Nystromformer technique, a Tucker tensor decomposition technique, a principle component analysis (PCA) decomposition technique, or a canonical polyadic tensor decomposition (CPD) technique.

16. The one or more non-transitory computer readable media of any of clauses 11-15, wherein the instructions, when executed by the one or more processors, further cause the one or more processors to perform the step of, in response to determining that the compressed trained machine learning model does not satisfy the predefined accuracy constraint, performing one or more operations to re-train the compressed trained machine learning model.

17. The one or more non-transitory computer readable media of any of clauses 11-16, wherein the instructions, when executed by the one or more processors, further cause the one or more processors to perform the step of performing one or more operations to fuse at least two layers included in the one or more layers to generate a fused layer.

18. The one or more non-transitory computer readable media of any of clauses 11-17, wherein the instructions, when executed by the one or more processors, further cause the one or more processors to perform the step of performing one or more operations to convert the compressed trained machine learning model to a binary format that is executable via the hardware device.

19. The one or more non-transitory computer readable media of any of clauses 11-18, wherein the one or more iterative operations are further based on a predefined constraint on a size of the compressed trained machine learning model.

20. In some embodiments, a system comprises one or more memories storing instructions, and one or more processors coupled to the one or more memories that, when executing the instructions, perform the steps of parsing the trained machine learning model to identify one or more layers of the trained machine learning model and, for each layer included in the one or more layers, one or more corresponding compression techniques that can be applied to compress the layer, performing, based on a hardware device on which the trained machine learning model is intended to execute, for each layer included in the one or more layers, a compression technique included in the one or more corresponding compression techniques and values of one or more parameters associated with the compression technique, and compressing each layer included in the one or more layers using the compression technique that is selected for the layer and the values of the one or more parameters associated with the compression technique to generate a compressed trained machine learning model.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module” or “system.” Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method for accelerating a trained machine learning model, the method comprising:
parsing the trained machine learning model to identify one or more layers of the trained machine learning model and, for each layer included in the one or more layers, one or more corresponding compression techniques that can be applied to compress the layer;
performing, based on a hardware device on which the trained machine learning model is intended to execute, one or more iterative operations to select, for each layer included in the one or more layers, a compression technique included in the one or more corresponding compression techniques and values of one or more parameters associated with the compression technique; and
compressing each layer included in the one or more layers using the compression technique that is selected for the layer and the values of the one or more parameters associated with the compression technique to generate a compressed trained machine learning model.

2. The computer-implemented method of claim 1, further comprising performing one or more quantization operations on the compressed trained machine learning model to generate a quantized trained machine learning model.

3. The computer-implemented method of claim 1, wherein the one or more iterative operations comprise one or more reinforcement learning operations.

4. The computer-implemented method of claim 1, where the compression technique included in the one or more corresponding compression techniques comprises at least one of a pruning technique, a decomposition technique, or an approximation technique.

5. The computer-implemented method of claim 1, wherein the one or more iterative operations are further based on at least one of a predefined accuracy constraint or a predefined execution speed constraint.

6. The computer-implemented method of claim 1, further comprising, in response to determining that the compressed trained machine learning model does not satisfy a predefined accuracy constraint, performing one or more operations to re-train the compressed trained machine learning model.

7. The computer-implemented method of claim 1, further comprising performing one or more operations to fuse at least two layers included in the one or more layers to generate a fused layer.

8. The computer-implemented method of claim 1, further comprising updating, based on user input, the one or more corresponding compression techniques for at least one layer included in the one or more layers.

9. The computer-implemented method of claim 1, further comprising performing one or more operations to convert the compressed trained machine learning model to a binary format that is executable via the hardware device.

10. The computer-implemented method of claim 1, wherein the trained machine learning model comprises a trained artificial neural network.

11. One or more non-transitory computer readable media including instructions that, when executed by one or more processors, cause the one or more processors to perform the steps of:
parsing a trained machine learning model to identify one or more layers of the trained machine learning model and, for each layer included in the one or more layers, one or more corresponding compression techniques that can be applied to compress the layer;
performing, based on a hardware device on which the trained machine learning model is intended to execute, one or more iterative operations to select, for each layer included in the one or more layers, a compression technique included in the one or more corresponding compression techniques and values of one or more parameters associated with the compression technique; and
compressing each layer included in the one or more layers using the compression technique that is selected for the layer and the values of the one or more parameters associated with the compression technique to generate a compressed trained machine learning model.

12. The one or more non-transitory computer readable media of claim 11, wherein the instructions, when executed by the one or more processors, further cause the one or more processors to perform the step of performing one or more quantization operations on the compressed trained machine learning model to generate a quantized trained machine learning model.

13. The one or more non-transitory computer readable media of claim 11, wherein the one or more iterative operations are further based on at least one of a predefined accuracy constraint or a predefined execution speed constraint.

14. The one or more non-transitory computer readable media of claim 11, where the compression technique included in the one or more corresponding compression techniques comprises at least one of a pruning technique, a decomposition technique, or an approximation technique.

15. The one or more non-transitory computer readable media of claim 11, where the compression technique included in the one or more corresponding compression techniques comprises at least one of a global pruning technique, a local pruning technique, a filter pruning via geometric median (FPGM) technique, a structured pruning technique, an unstructured pruning technique, an Energy Threshold (QR) technique, a Nystromformer technique, a Tucker tensor decomposition technique, a principle component analysis (PCA) decomposition technique, or a canonical polyadic tensor decomposition (CPD) technique.

16. The one or more non-transitory computer readable media of claim 11, wherein the instructions, when executed by the one or more processors, further cause the one or more processors to perform the step of, in response to determining that the compressed trained machine learning model does not satisfy the predefined accuracy constraint, performing one or more operations to re-train the compressed trained machine learning model.

17. The one or more non-transitory computer readable media of claim 11, wherein the instructions, when executed by the one or more processors, further cause the one or more processors to perform the step of performing one or more operations to fuse at least two layers included in the one or more layers to generate a fused layer.

18. The one or more non-transitory computer readable media of claim 11, wherein the instructions, when executed by the one or more processors, further cause the one or more processors to perform the step of performing one or more operations to convert the compressed trained machine learning model to a binary format that is executable via the hardware device.

19. The one or more non-transitory computer readable media of claim 11, wherein the one or more iterative operations are further based on a predefined constraint on a size of the compressed trained machine learning model.

20. A system comprising:
one or more memories storing instructions; and
one or more processors coupled to the one or more memories that, when executing the instructions, perform the steps of:
parsing the trained machine learning model to identify one or more layers of the trained machine learning model and, for each layer included in the one or more layers, one or more corresponding compression techniques that can be applied to compress the layer,
performing, based on a hardware device on which the trained machine learning model is intended to execute, for each layer included in the one or more layers, a compression technique included in the one or more corresponding compression techniques and values of one or more parameters associated with the compression technique, and
compressing each layer included in the one or more layers using the compression technique that is selected for the layer and the values of the one or more parameters associated with the compression technique to generate a compressed trained machine learning model.
